(19) United States
(12) Patent Application Publication
(10) Pub. No.: US 2006/0063874 A1
(43) Pub. Date: Mar. 23, 2006

(54) Incombustible polyolefin resin composition

(76) Inventors: Ki Do Lee, Daesan-eup Seosan-si (KR); Jae Whan Cho, Anyang-si (KR); Man Saeng Her, Seosan-si (KR)

Correspondence Address: BARLOW, JOSEPHS & HOLMES, LTD., 101 DYER STREET, 5TH FLOOR, PROVIDENCE, RI, 02903, US

(21) Appl. No.: 11/141,888

(22) Filed: Jun. 1, 2005

(30) Foreign Application Priority Data
Sep. 20, 2004 (KR) 10-2004-0074949

(51) Int. Cl. C08K 3/22; C08K 3/34

(52) U.S. Cl. 524/436; 524/445

(57) ABSTRACT

An incombustible polyolefin resin composition, particularly, an incombustible polyolefin resin composition comprising polyethylene resin, ethylene vinylacetate resin, inorganic hydroxide flame retardant and nano-clay. The composition has improved resin processability, product flexibility and non-dripping properties due to reduced specific weight while maintaining or improving incombustibility, by using a nano-clay additionally and an inorganic hydroxide flame retardant with a reduced content, as compared to the conventional incombustible polyolefin resin composition.

### TECHNICAL FIELD

The present invention relates to an incombustible polyolefin resin composition, particularly, an incombustible polyolefin resin composition comprising polyethylene resin, ethylene vinylacetate resin, inorganic hydroxide flame retardant and nano-clay, improving resin processability, product flexibility and non-dripping property due to reduced specific weight while maintaining or improving incombustibility, by using a nano-clay additionally and an inorganic hydroxide flame retardant with a reduced content, as compared to the conventional incombustible polyolefin resin composition.

### BACKGROUND ART

An incombustible polyolefin resin composition and molded article thereof, when fire breaks out, generally lead to extinguishment or suppress spread of flames, owing to the characteristics of the resin composition, incombustibility. In order to impart such incombustibility to a polyolefin resin composition, which is basically combustible, halogen type flame retardants have been mainly used to a resin composition conventionally. However, restrictions on the use of the halogen containing flame retardants are extended more and more, since an incombustible resin composition comprising a halogen containing flame retardant has a significant problem of the generation of toxic gases in fire, wherein the gases may cause adverse health effects on those exposed. On this circumstance, as an alternative, there has been rapidly increasing demands for an incombustible polyolefin resin composition comprising a phosphorous flame retardant or an inorganic hydroxide flame retardant.

Meanwhile, a phosphorous flame retardant, particularly a phosphorous flame retardant based on phosphate ester compounds, when used in a polyolefin resin composition, deteriorates the physical properties and heat resistance of the resin composition, and thus it is not suitably used as an additive which can impart incombustibility to a polyolefin resin composition

Therefore, various techniques have been recently researched and developed, which employ addition of an inorganic hydroxide flame retardant, particularly aluminum hydroxide or magnesium hydroxide to a polyolefin resin composition (See, Korean registered patent Nos. 375665, 385369 and 391966, and Korean patent laid-open application No. 2001-83534). In the above-mentioned techniques, aluminum hydroxide and/or magnesium hydroxide is added to a polyolefin resin composition for imparting incombustibility, and a compatibilizer having a specific composition is also used with a specific ratio, to prevent deterioration of resin processability and product flexibility owing to the addition of the inorganic flame retardant.

The said techniques using inorganic hydroxide flame retardant, however, involve problems such as high production cost and complicated processes, since they require the excessive use of the inorganic flame retardant for obtaining a desired level of incombustibility and additional use of the compatibilizer.

In the meantime, a nano-clay, a material useful for car interior or exterior finishing materials, electronic parts, packaging materials, aircraft parts and the like, is under active investigation for its development. A nano-clay, which is a platelet material having a nanometer scale thickness, can dramatically improve various properties including strength, heat resistance, gas barrier property and the like. As currently known techniques, there are those employing the addition of a nano-clay for imparting thermal stability and abrasion resistance to a rubber composition, or those using a nano-clay together with a phosphorus flame retardant for imparting flame retardancy to synthetic resin products where high modulus and strength are required, such as a polycarbonate resin or ABS resin (See Korean patent laid-open application Nos. 2002-47892 and 2002-27701).

Those techniques may be suitably applicable to tire rubber compositions and a polycarbonate resin or ABS resin, however when applying to polyolefin resin compositions, they will cause problems in aspects of resin processability, product flexibility and the like.

Therefore, there are still demands for the development of an incombustible polyolefin resin composition, which can provide a desired level of incombustibility without using a halogen containing flame retardant and simultaneously provide excellent resin processability and flexibility, product flexibility and the like.

### OBJECT OF THE INVENTION

The present invention is designed to solve the problems of the conventional arts, and is to provide an incombustible polyolefin resin composition, which has a desired level of incombustibility and non-dripping property without using halogen containing flame retardants, and has excellent resin processability and flexibility so as to be directly applicable to a typical extrusion process and to form a molded article having excellent flexibility.

### DETAILED DESCRIPTION OF THE INVENTION

According to the present invention, an incombustible polyolefin resin composition is provided, which comprises 25˜40 wt % of polyethylene resin, 1˜10 wt % of ethylene vinylacetate resin, 48˜65 wt % of inorganic hydroxide flame retardant and 2˜10 wt % of nano-clay.

The polyethylene resin used in the incombustible polyolefin resin composition according to the present invention preferably has a density of 0.89˜0.96 g/cm³ and a melt index(MI)(measured according to ASTM D1238, under 2.16 kg load, at 190° C.) of 4˜40 g/10 minutes, and is preferably used in an amount of 25˜40 wt % in the composition. When the content is less than 25 wt %, the flexibility of the resin composition may not be sufficiently obtained so that it becomes difficult to apply the composition to an extrusion process, while when the content is more than 40 wt %, incombustibility of the resin composition is dramatically decreased due to combustibility of the polyethylene.

For the ethylene vinylacetate resin used in the incombustible polyolefin resin composition according to the present invention, those having 10˜27 wt % of a vinylacetate content are preferred, and the resin is preferably used in an amount of 1˜10 wt % in the incombustible polyolefin resin composition. When the content of the ethylene vinylacetate resin is less than 1 wt %, occurred are problems such that the flexibility of the resin composition becomes insufficient, the dispersion of the added flame retardant and nano-clay in the resin composition becomes non-uniform, and when the resulted resin composition is used being attached to an aluminum panel and the like, adhesion to the panel becomes insufficient. However, when the content of the ethylene vinylacetate resin is more than 10 wt %, a problem of dramatic decrease in incombustibility and non-dripping property of the resin composition is occurred.

For the inorganic hydroxide flame retardant contained in the incombustible polyolefin resin composition according to the present invention, any inorganic hydroxide which can be used as an additive imparting flame retardancy or incombustibility to the composition would be acceptable without particular limitation, and it is preferably selected from the group consisting of aluminum hydroxide, magnesium hydroxide and mixtures thereof, wherein the hydroxide flame retardant is preferably used in an amount of 48˜65 wt % in the incombustible polyolefin resin composition of the present invention. When the content is less than 48 wt %, it is impossible to obtain a desired level of incombustibility. While, when it is more than 65 wt %, owing to the excessive content of the inorganic material, the resin processability and flexibility is deteriorated and as a result, processing load becomes increased, which makes the extrusion processing and continuous processing very difficult.

The average particle size of the inorganic hydroxide flame retardant is preferred to be in the range of about 0.5˜25 μm. When the mean average particle size is in the range of less than about 0.5 μm, it causes decrease in productivity due to increased load in extrusion processing, while when the average particle size is in the range of more than about 25 μm, the surface area of the added hydroxide flame retardant becomes lower so that the binding force with the resin may become insufficient in the resin composition, thereby finally deteriorating the incombustibility of the resin composition.

The nano-clay contained in the incombustible polyolefin resin composition according to the present invention, is used for the purpose of imparting incombustibility and non-dripping property to the resin composition of the present invention. The addition of the nano-clay makes the amount of use of said inorganic hydroxide flame retardant reduced as compared to the conventional techniques, and thus contributes to the improvement of processability and flexibility of the resin composition. For the nano-clay, there is no particular limitation as long as it is a clay in nanometer scale which can suitably used as an additive imparting flame retardancy or incombustibility and non-dripping property to the resin composition, but it is preferably at least one selected from the group consisting of montmorillonite, hectorite, saponite, nontronite, beidellite, vermiculite and halloysite. The nano-clay is preferred to have a basal spacing of 5˜30 Å, a average particle size of 5˜15 microns and a density of 1.5˜2.5 g/cm², in view of processability, flexibility, flame retardancy or incombustibility and non-dripping property of the resin composition.

Further, the nano-clay is preferably those organically modified with an amine compound. The organic modification of nano-clay is one of the conventional surface treatment to a nano-clay, wherein metal cation on the surface of the nano-clay is exchanged for organic cation by treating the nano-clay with an amine compound such as alkyl ammonium compound. When the nano-clay is organically modified, its polarity and accordingly hydrophilicity becomes reduced so that it can be more smoothly mixed with the resin components which have high lipophilicity, and as a result, the nano-clay can be more effectively dispersed into the resin composition.

It is preferred for the nano-clay, preferably organically modified nano-clay, to be used in an amount of 2˜10 wt % in the incombustible polyolefin resin composition of the present invention. When the content of the nano-clay is less than 2 wt %, a desired level of incombustibility and non-dripping property cannot be obtained, while when the content is more than 10 wt %, processability and flexibility of the resin are deteriorated.

The incombustible polyolefin resin composition may further comprise talc. Talc, which can be those conventionally used in preparation of complex materials, is used for applying additional incombustibility to the composition, preferably in an amount of 1˜15 wt %. When the content of talc is less than 1 wt %, the effect of the additional use of talc is not expected, while when the content is more than 15 wt %, processability of the resin is deteriorated.

The incombustible polyolefin resin composition according to the present invention may optionally comprise, other than above-described components, various additives conventionally used in preparation of a polyolefin resin composition, for example an antioxidant, a thermal stabilizer, zinc-stearate(Zn-St) and the like, within the range which not interfere the purpose of the present invention.

The incombustible polyolefin resin composition of the present invention may be prepared by the exemplary process given below. Above-described each component of the composition is charged into a melt mixer with each specific ratio, kneaded in melt at 100° C. for 10˜30 minutes depending on the composition ratio, and pelletized at 160˜200° C. through an extruder to provide an incombustible polyolefin resin composition in pellet form.

Since the incombustible polyolefin resin composition of the present invention has excellent processability and flexibility, it can be widely applied to prepare a core material of complex panels having multilayer structure such as metal/binding layer/incombustible polyolefin resin composition layer, aluminum/binding layer/incombustible polyolefin resin composition layer/binding layer/aluminum, glass/binding layer/incombustible polyolefin resin composition layer and aluminum/binding layer/incombustible polyolefin resin composition layer/binding layer/metal; a sheet for an interior finishing material of a building; a complex panel material for civil engineering construction material; and the like, by using conventional polyolefin resin processing methods such as T-die extrusion and the like.

Hereinafter, the present invention is further described in detail referencing the following examples and comparative examples, however those examples are only provided as an illustrative purpose, by no means restricting the scope of the present invention.

### EXAMPLES

### Examples 1˜7 and Comparative Examples 1˜4

For each example and comparative example, the specified components with their specified ratio, as represented in table 1, were charged into a melt mixer, kneaded in melt at 100° C. for about 20 minutes, and pelletized by a single screw extruder (50 mm ψ) at 160˜200° C., thereby obtaining the incombustible polyolefin resin composition according to the present invention in pellet form. The resulted resin composition was fabricated to a sheet having a thickness of 3 mm, and heat-sealed with an aluminum panel having a thickness of 0.5 mm by using an adhesive film, thereby obtaining an aluminum complex panel having a total thickness of 4 mm as a test specimen for testing combustion properties.

For testing combustion properties, each specimen prepared for examples and comparative examples respectively was subjected to a surface test, an addition test and a smoke toxicity test according to the methods specified in KS F 2271 for estimating the acceptability in incombustibility, and non-dripping properties were further estimated through the observation of the combustion process with naked eyes. The results of the estimation on combustion properties and non-dripping observation are shown in table 1 below.

Further, for estimating the processability, each load applied to the single screw extruder during the extrusion corresponding to each example and comparative example was measured, and the measured loads were used as an index for processability estimation. The results of the measured load on the extruder (ampere, A) are represented in the processability row of the table 1. The smaller the load, the better the processability is.

For estimating flexibility, test specimens (3×20×120 mm) were prepared by using each pelletized incombustible polyolefin resin composition corresponding to the examples and comparative examples respectively. Each specimen was bent by the force applied to its center, at the speed of 60 mm/minute with a press brake (manufactured by Instron corp.) and when reaching to the bending limit, the radius of curvature was measured. The results of the measured radius curvature(mmR) at the bending limit were represented in the flexibility row of the table 1. The smaller the radius of curvature, the better the flexibility is.

TABLE 1

| | | | | | | | | | Comparative | | | |
|---|---|---|---|---|---|---|---|---|---|---|---|---|
| | | Examples | | | | | | | examples | | | |
| | | 1 | 2 | 3 | 4 | 5 | 6 | 7 | 1 | 2 | 3 | 4 |
| Components | PE | 30 | 35 | 30 | 30 | 35 | 30 | 30 | 20 | 20 | 45 | 45 |
| and | EVA | 5 | 5 | 5 | 5 | 5 | 5 | 5 | 5 | 5 | 5 | 5 |
| content | Al(OH)₃ | 60 | 55 | 55 | 50 | — | — | — | 70 | 70 | 50 | 45 |
| thereof | Mg(OH)₂ | — | — | — | — | 55 | 55 | 50 | — | — | — | — |
| (wt %) | Nano-clay | 5 | 5 | 5 | 5 | 5 | 5 | 5 | — | 5 | — | 5 |
| | talc | — | — | 5 | 10 | — | 5 | 10 | 5 | — | — | — |
| Incombustibility | Surface test | ◯ | ◯ | ◯ | ◯ | ◯ | ◯ | ◯ | X | ◯ | X | X |
| | Addition test | ◯ | ◯ | ◯ | ◯ | ◯ | ◯ | ◯ | X | ◯ | X | X |
| | Smoke toxicity | ◯ | ◯ | ◯ | ◯ | ◯ | ◯ | ◯ | ◯ | ◯ | X | X |

| | | | | | | | | | | | |
|---|---|---|---|---|---|---|---|---|---|---|---|
| Non-dripping property | ◯ | ◯ | ◯ | ◯ | ◯ | ◯ | ◯ | X | ◯ | X | ◯ |
| Processability(A) | 12.4 | 12.5 | 13.1 | 13.4 | 11.3 | 12.0 | 12.2 | 20.1 | 20.2 | 8.2 | 7.8 |
| Flexibility (radius of | 91 | 81 | 87 | 86 | 74 | 77 | 77 | 118 | 120 | 60 | 58 |
| curvature, mmR) | | | | | | | | | | | |

note)
PE: polyethylene resin (Product name 610A, manufactured by Samsung-Atofina, density 0.92 g/cm³, MI 4 g/10 min.)
EVA: ethylene vinylacetate resin (Product name 210F, manufactured by Samsung-Atofina, vinyl acetate content 21 wt %)
Al(OH)₃: aluminum hydroxide
Mg(OH)₂: magnesium hydroxide (Kisuma 5B, manufactured by Kyowa corp., Japan)
Nano-clay: organo-montmorillonite (Cloisite 10A, manufactured by Southern clay products corp.; the basal spacing is about 19 Å, the average particle size of about 5˜10 microns, the density of about 1.9 g/cm³)
In the surface test, addition test and smoke toxicity test - ◯: acceptable, X: not acceptable
Non-dripping property - ◯: non-dripping, X: dripping

As seen from the results shown in Table 1, the polyolefin resin compositions according to the examples of the present invention have improved incombustibility by comprising nano-clay, in spite of the reduced content of the inorganic hydroxide flame retardant as compared to comparative example 1.

Further, in the resin composition of comparative example 2, even though its incombustibility is improved by comprising the nano-clay, the processability and the flexibility are reduced owing to the excessive amount of the inorganic hydroxide flame retardant.

In the resin compositions of comparative examples 3 and 4, the processability and the flexibility are improved by using the reduced amount of the inorganic hydroxide flame retardant and the increased amount of the polyolefin resin, however the incombustibility is deteriorated.

From the above results, it can be known that the polyolefin resin composition comprising the specific components with specific ratio according to the present invention, simultaneously has excellent processability and flexibility as well as incombustibility.

### INDUSTRIAL APPLICABILITY

As seen from the above, the polyolefin resin composition according to the present invention has excellent incombustibility as much as it passes the 2^{nd} grade incombustibility test according to KS F 2271, in spite of containing the reduced amount of an inorganic hydroxide flame retardant as compared to the conventional incombustible resin compositions, and excellent processability so that it is applicable to a conventional processing equipment for typical polyolefin resin compositions, owing to the reduced amount of the inorganic flame retardant, and it makes possible to produce incombustible molded articles having superior flexibility as compared to the conventional incombustible resin composition. Additionally, the incombustibility of the resin composition of the present invention may be more improved by further comprising talc.

What is claimed is:

1. An incombustible polyolefin resin composition comprising 25˜40 wt % of polyethylene resin, 1˜10 wt % of ethylene vinylacetate resin, 48˜65 wt % of inorganic hydroxide flame retardant and 2˜10 wt % of nano-clay.

2. The incombustible polyolefin resin composition according to claim 1, wherein the polyethylene resin has a density of 0.89˜0.96 g/cm³, and a melt index of 4˜40 g/10 minutes.

3. The incombustible polyolefin resin composition according to claim 1, wherein the ethylene vinylacetate resin has a vinylacetate content of 10˜27 wt %.

4. The incombustible polyolefin resin composition according to claim 1, wherein the inorganic hydroxide flame retardant is selected from the group consisting of aluminum hydroxide, magnesium hydroxide and mixtures thereof.

5. The incombustible polyolefin resin composition according to claim 1, wherein the inorganic hydroxide flame retardant has a average particle size within a range of 0.5˜25 μm.

6. The incombustible polyolefin resin composition according to claim 1, wherein the nano-clay is at least one selected from the group consisting of montmorillonite, hectorite, saponite, nontronite, beidellite, vermiculite and halloysite.

7. The incombustible polyolefin resin composition according to claim 1, wherein the nano-clay is organically modified with amine compound.

8. The incombustible polyolefin resin composition according to claim 1 further comprising talc.

9. The incombustible polyolefin resin composition according to claim 2 further comprising talc.

10. The incombustible polyolefin resin composition according to claim 3 further comprising talc.

11. The incombustible polyolefin resin composition according to claim 4 further comprising talc.

12. The incombustible polyolefin resin composition according to claim 5 further comprising talc.

13. The incombustible polyolefin resin composition according to claim 6 further comprising talc.

14. The incombustible polyolefin resin composition according to claim 7 further comprising talc.
